(19) United States
(12) Patent Application Publication
(10) Pub. No.: US 2021/0036538 A1
(43) Pub. Date: Feb. 4, 2021

(54) WIRELESS CHARGING OF PORTABLE TOOLS

(71) Applicant: ChargEdge, Inc., Fremont, CA (US)

(72) Inventor: Sanjaya Maniktala, Fremont, CA (US)

(21) Appl. No.: 16/851,042

(22) Filed: Apr. 16, 2020

Related U.S. Application Data
(60) Provisional application No. 62/834,566, filed on Apr. 16, 2019.

(51) Int. Cl. H02J 7/04; H02J 50/70; H02J 50/00; B25B 29/00; H02J 50/10; H02J 50/40

(52) U.S. Cl. CPC H02J 7/04; H02J 50/70; H02J 50/402; B25B 29/00; H02J 50/10; H02J 50/005

(57) ABSTRACT

A battery-powered tool comprising a control circuit, a rechargeable battery connected to the control circuit and configured to provide electrical power to the tool, the battery having a nominal battery voltage, and a receiver circuit connected to the control circuit and configured to be electromagnetically coupled to a transmitter coil structure located external to the tool. The receiver circuit comprises a receiver coil structure having a longitudinal axis that is configured to direct flux induced by the transmitter coil in a transverse direction such that an output voltage of the receiver circuit is provided to the control circuit for charging of the battery, the output voltage being larger than the nominal battery voltage.

### CROSS-REFERENCE

This application claims the benefit of U.S. Provisional Patent Application No. 62/834,566, entitled “Wireless Charging of Portable Tools” filed on Apr. 16, 2019 the subject matter of which is hereby incorporated by reference in its entirety.

### FIELD

The present disclosure relates to devices that facilitate the wireless charging of portable tools, and methods of wireless charging of portable tools.

### BACKGROUND

Wireless power transfer (WPT) involves the use of time-varying magnetic fields to wirelessly transfer power from a source to a device. Faraday's law of magnetic induction provides that if a time-varying current is applied to one coil (e.g., a transmitter coil) a voltage will be induced in a nearby second coil (e.g., a receiver coil). The voltage induced in the receiver coil can then be rectified and filtered to generate a stable DC voltage for powering an electronic device or charging a battery. The receiver coil and associated circuitry for generating a DC voltage can be connected to or included within the electronic device itself such as a power tool, medical instrument, smartphone or other portable device.

A typical battery powered device 100 is shown in FIG. 1. Device 100 comprises battery pack 110 comprising battery 112 electrically connected to a controller having a built-in circuit board 114. The controller has two main power terminals, a positive terminal 116 and a negative terminal 118. A power tool 120 is electrically coupled to the terminals 116, 118 of the controller circuit 114. The battery 112 may be recharged via a battery charging station 130. Battery charging station 130 is a separate entity and is external to the power tool 120. The controller circuit 114 allows the voltage from the battery 112 to appear on the terminals 116, 118 when the battery 112 is not being charged. Such voltage on the terminals 116, 118 is provided to the power tool 120 for operation.

Typically, in order to charge the battery 112, the battery 112 and associated controller circuitry 114 would need to be disconnected from the tool 120. Once disconnected, the battery pack 110 would then be plugged into the charging station 130, which in turn makes a hard connection to the power terminals 116, 118 of the controller circuit 114. A voltage would then be applied to these terminals 116, 118, in which the charging station 130 directs power to flow into battery 112 in order to restore charge to the battery. The source of power in the charging station 130 is usually provided by a mains power supply. FIG. 2 shows two exemplary rechargeable battery packs 112A, 112B that have been removed from their respective tools and plugged into the charging station 130. Each of battery pack 112A and 112B comprise a rechargeable battery 112 and its controller circuit 114.

However in most situations, the tool 120 is limited in that the battery 112 cannot be charged while the tool 120 is being used as the battery pack 110 always needs to be physically disconnected from the tool 120 and connected to the charging station 130. For example, in FIG. 2, the battery packs 110A and 110B are disconnected from their respective tools 120 and plugged into the charging station 130. Once the battery 112 has been charged, the battery pack 110 is re-attached to the power tool 120 as shown in FIG. 3 where the terminals 116, 118 of the controller circuit 114 re-establish an electrical connection with the tool 120 such that power from the charged battery 112 can be provided to the tool 120.

There is therefore a need to minimize disruption of the use of the tool 120, and to simplify the charging of the batteries 112 associated therewith.

### SUMMARY

According to an embodiment of the present disclosure there is provided a battery-powered device comprising a control circuit, a rechargeable battery and a receiver circuit. The rechargeable battery is connected to the control circuit and configured to provide electrical power to the device, the battery having a nominal battery voltage. The a receiver circuit connected to the control circuit and configured to be electromagnetically coupled to a transmitter coil structure located external to the device. The receiver circuit comprises a receiver coil structure having a longitudinal axis that is configured to direct magnetic flux induced by the transmitter coil in a transverse direction such that an output voltage of the receiver circuit is provided to the control circuit for charging of the battery.

### BRIEF DESCRIPTION OF DRAWINGS

The foregoing and other objects and advantages will be apparent upon consideration of the following detailed description, taken in conjunction with the accompanying drawings, in which like reference characters refer to like parts throughout, and in which:

FIG. 1 shows a schematic representation of an exemplary circuit for wireless power transfer to a power device, such as a power tool, according to one or more embodiments of the present disclosure;

FIG. 2 illustrates an external charging station used for charging battery packs of the device of FIG. 1;

FIG. 3 illustrates a battery pack of FIG. 2 attached to the power device of FIG. 1, for the operation thereof;

FIGS. 4A-4C illustrate various views of wireless power transfer to the power device of FIG. 1 from a wireless power transmitter, according to one or more embodiments of the present disclosure;

FIG. 5 shows a schematic representation of an exemplary circuit for wireless power transfer to a power device with receiver coils connected in parallel, according to one or more embodiments of the present disclosure; and

FIG. 6 shows a schematic representation of an exemplary circuit for wireless power transfer to a power device with receiver coils connected in series, according to one or more embodiments of the present disclosure.

### DETAILED DESCRIPTION

To provide an overall understanding of the devices described herein, certain illustrative embodiments will be described. Although the embodiments and features described herein are specifically described for use in connection with wireless charging of portable tools, it will be understood that all the components and other features outlined below may be combined with one another in any suitable manner and may be adapted and applied to other types of devices requiring power from rechargeable power sources such as batteries.

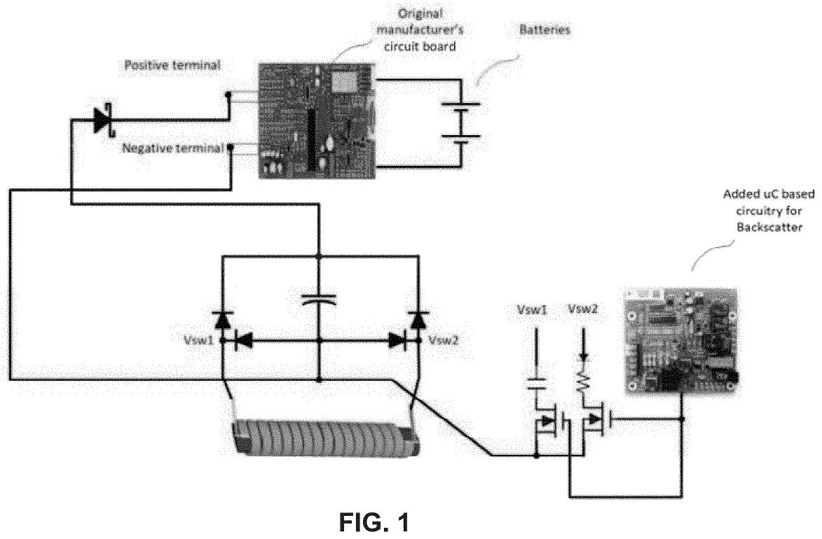

FIG. 1 shows an exemplary embodiment of the present disclosure. In addition to the battery pack 110 comprising the rechargeable battery 112 and the controller circuit 114 as shown in FIG. 1, an embodiment of the present disclosure further includes an additional circuit board for a wireless power receiver (Rx) 140. Wireless power receiver 140 comprises a longitudinal receiver coil 142 electrically connected to a rectifying circuit 144, such as a full bridge rectifier, for example, optionally coupled with a smoothing capacitor 146. The rectifying circuit 144 comprises switching nodes at which switching voltage signals Vsw1and Vsw2 are made available. A current is induced in the receiver coil 142 when the wireless power receiver 140 is in proximity to a power transmitter (not shown) emitting a magnetic flux. Longitudinal receiver coil 142 as shown in FIG. 1 comprises a wire wound around a ferromagnetic core. Such longitudinal coils direct the flux in a transverse (horizontal) direction to avoid eddy current heating in a metal casing of the battery 112 and other stray metals in the circuit board within the wireless power receiver 140. In some embodiments, other types of coil structures such as single spiral coils, multiple spiral coils, longitudinal coils, or coils having any polarity structure, for example, could be used. In certain embodiments, ferrite shielding may also be included in the structure of the receiver coil 142.

In certain embodiments, the additional circuit board for the wireless power receiver 140 may be integrated into a casing for the pack 110 housing the battery 112. In this manner, the wireless power receiver 140 need not have its own separate terminals. Rather, the wireless power receiver 140 may be electrically coupled to the positive terminal 116 and the negative terminal 118 of the controller circuit 114 which is coupled to the battery 112, as shown in FIG. 1. This results in a modified battery pack 160, as delineated in FIG. 1, and would pose no change to the power tool 120. Here the power tool 120 would be attached to the terminals 116, 118 of the control circuit 114. However terminals 116, 118 are also used to connect the power tool 120 to the wireless power receiver 140. When a current is induced in the receiver coil 142 of the wireless power receiver 140, the induced current flows into the controller circuit 114 via the terminals 116, 118 to charge the battery 112.

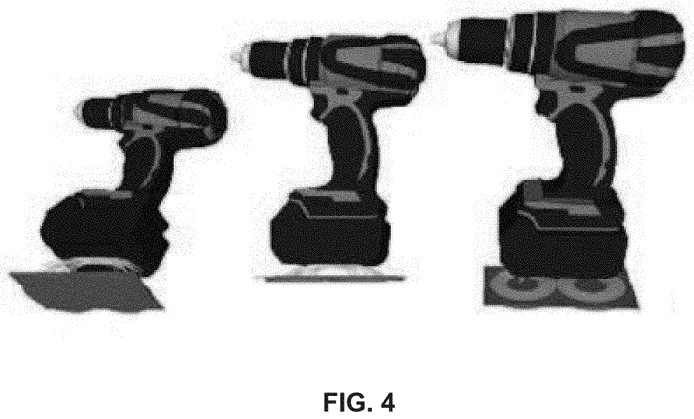

When the battery 112 requires charging, the entire power tool 120 attached with the modified battery pack 160 can be brought into proximity to a power transmitter (Tx) 410 as shown in FIGS. 4A-4C below. As previously mentioned, the modified battery pack 160 may have the wireless power receiver Rx 140 integrated therein (see FIG. 4A). This induces a current in the receiver coil 142 of the wireless power receiver 140 to charge the battery 112, without having to detach the battery pack from the power tool 120. Thus, during use, a user simply needs to intermittently place the power tool 120, with the modified battery pack 160 attached, onto a charging station having a wireless power transmitter contained therein to charge the battery 112.

In some embodiments, the wireless power receiver 140 is connected to the terminals 116, 118 of the control circuit 114 via a diode 148. The diode 148 may comprise a field-effect transistor (FET) based synchronous diode. Diode 148 may be connected to either terminal 116, 118, or a diode 148 may be connected to each terminal 116, 118.

In some embodiments, the wireless power receiver 140 further comprises a backscatter circuit 150 to modulate one or both of the switching node voltage signals Vsw1 and Vsw2 of the rectifier circuit 144. The backscatter circuit 150 may comprise a microcontroller 152 and other modulation circuitry as is known in the field. In certain embodiments, resistive or capacitive modulation techniques, or a combination of both are used. In some embodiments, the a voltage divider circuit or an operational amplifier circuit may be connected to the microcontroller 152 of the backscatter circuit 150. The output voltage of the wireless power receiver 140 may be set through the voltage divider circuit or the operational amplifier circuit connected to the microcontroller 152 of the backscatter circuit 150.

In some embodiments, the output voltage may be set slightly higher than the nominal battery voltage as seen on the terminals 116, 118 in FIG. 1. When a current is induced in the wireless power receiver 140, the output voltage would rise to the set value and in so doing eventually exceeding the nominal battery voltage. This causes the diode 148 to become forward biased thereby allowing the induced current to enter and charge the battery 112. Such charging current would be controlled and regulated by a control circuit 114 on the original manufacturer's circuit board.

In some embodiments the wireless receiver 140 has a preset target output voltage suitable for the battery 112 to be charged. In some embodiments, the wireless power receiver 140 may include other electronic circuit components as are known in the field to control the rate at which the output voltage increases to the target output voltage. In some embodiments, the wireless power receiver 140 may be configured such that a gradual ramp up of output voltage is presented to the terminals 116, 118 of the control circuit 114. Further, in some embodiments, the wireless power receiver may be configured to detect the voltage at which the diode 148 becomes forward biased at which point charging current flows into the controller 114 and the battery 112. This enables the wireless power receiver 140 to “learn” the nominal output voltage suitable for the battery and self-calibrate itself. This is particularly advantageous and allows for the wireless power receiver 140 to be integrated into commercially available battery packs.

FIGS. 4A-4C show various views of setup 400 for charging a modified battery pack 160 attached to a power tool 120, according to an embodiment of the present disclosure. As previously mentioned, the modified battery pack 160 comprises the wireless power receiver (Rx) 140 integrated with the battery pack 110. When the battery 112 requires charging, the power tool 120 with the modified battery pack 160 is brought into proximity with a power transmitter (Tx) 410 as shown in FIG. 4A. According to an embodiment of the present disclosure, the power transmitter 410 may comprise a plurality of wire coils 430 of any configuration connected to a power supply (not shown). In some embodiments, the power transmitter 400 may also comprise a ferromagnetic layer 420 upon which the wire coils 430 are laid. The wire coils 430 may each have a longitudinal axis.

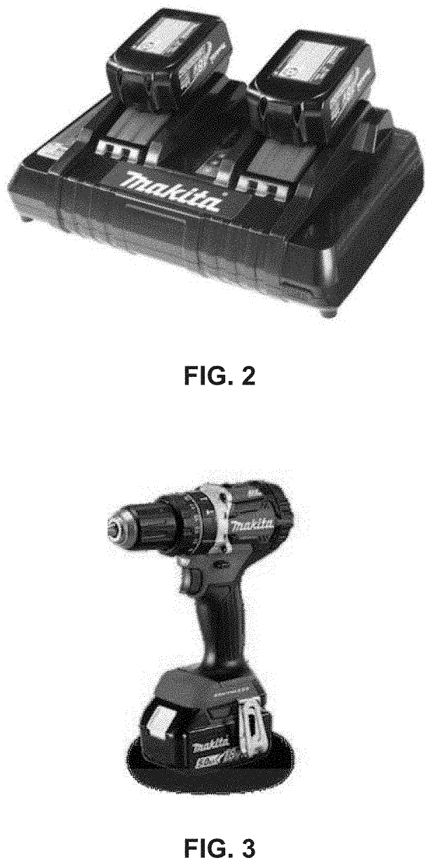

When a time-varying current from the power supply flows in the wire coils 430 of the power transmitter 410, a magnetic flux is produced, exemplified by magnetic field lines 440 as shown in FIGS. 4B-4C. The magnetic flux produced by the power transmitter 410 induces a corresponding magnetic flux in the wireless power receiver 140 in a transverse direction. This generates the output voltage in the wireless power receiver 140 for charging the battery 112 contained in the modified battery pack 160, as described in the foregoing. In this manner, the power tool 120 and the modified battery pack 160 need not be disconnected and the battery pack plugged into the charging station 130 as shown in FIG. 2. Instead, the power tool 120 with the modified battery pack 160 simply needs to be placed on or positioned near the power transmitter 410 as shown in FIGS. 4A-4C intermittently during operation of the power tool 120 to recharge the battery 112 as and when needed.

In some environments, such as an operating room in a medical facility, extensive disinfecting of batteries is required prior to use. According to an embodiment of the present disclosure, there is provided a method in which batteries, whether connected to tools or not, are capable of being constantly charged in said environments, thus minimizing chances of contamination should the battery need to be removed and recharged separately on a charging station located outside of the sterile environment. In certain embodiments involving a medical device instead of a power tool, the wireless power transmitter may be hermetically sealed in a casing or housing. Such a hermetically sealed transmitter may therefore be permanently located in a sterile environment, which would remain germ free, either after a simple wipe-down. In other embodiments, the power transmitter could be included in a sterilizing machine, such as an autoclave, which allows the battery 112 of the medical device 120 to be charged while being sterilized.

It should be noted that embodiments of the present disclosure have no exposed metal contacts or terminals for connection of the tool 120 or the battery 112 to each other or to the charging station 130 as such change of connections for charging the battery 112 is no longer necessary. According to the aforementioned embodiments of the present disclosure, the wireless power receiver 140 may be permanently connected to the terminals 116, 118 of the controller circuit 114. Further, the modified battery pack 160 may be attached to the power tool or medical device 120 even during recharging, thereby doing away with exposure of any metal contacts or terminals. This would allow for the power tool/medical device 120 and battery pack 120 to be located in a sterile environment without requiring any component thereof to be removed from the sterile environment to be re-charged. In this manner the nature of the sterile environment is not compromised as the power tool/medical device 120 and battery pack 120 can be present in the sterile environment (e.g. operating room) to charge up the power tool/medical device, if required, providing a more reliable experience for medical professionals. In some implementations of the present disclosure, the power tool/medical device may be charged in the sterile environment by a hermetically sealed power transmitter, such as transmitter 410 as shown in FIGS. 4A-4C. Note that hermetically sealed wireless power receivers may be known in the art, but hitherto, the aforementioned advantages of a hermetically sealed wireless power transmitter are new in the art. This has the capability of creating an entirely new paradigm in the medical industry.

According an embodiment of the present disclosure, there is also provided an entire portable tool, hermetically sealed, with no output connectors, and capable of being wirelessly charged as per the aforementioned embodiments. No longer would it be necessary even to have batteries which need to be disconnected from the tool. This would be beneficial especially in environments where germs or flammable gases can be present.

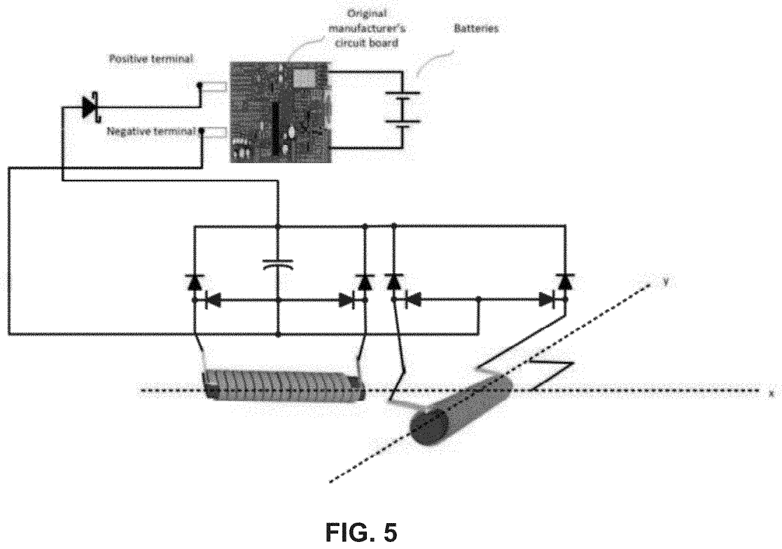

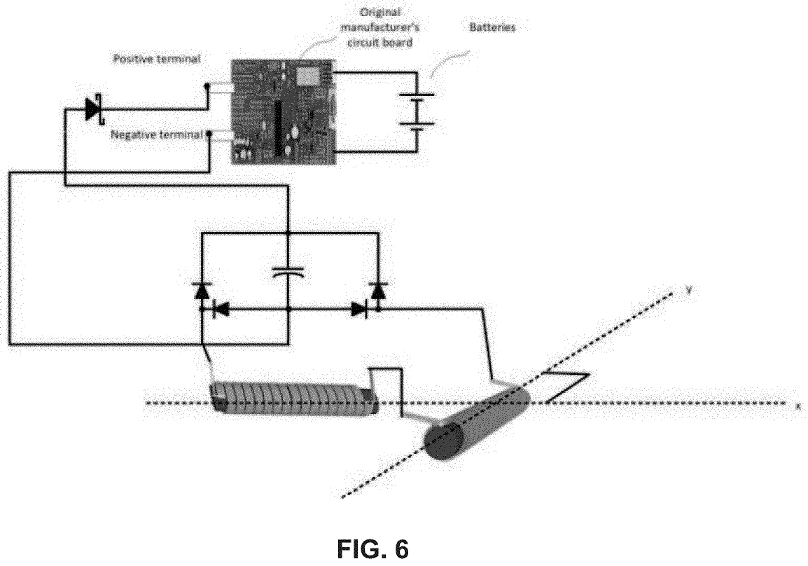

FIG. 5 shows a modified battery pack 500 according to an embodiment of the present disclosure. Modified battery pack 500 is similar to modified battery pack 160 as shown in FIG. 1, with the exception that the wireless power receiver 540 comprises receiver coils 542, 543. In FIG. 5, the receiver coils 542, 543 are connected in parallel or OR-ed together, however the receiver coils may also be connected in series (as shown in FIG. 6). In the implementation shown in FIG. 5, the two receiver coils 542, 543 are arranged at right angles to each other to provide full x-y rotational capability for wireless charging. In FIG. 5, each of the of the receiver coils 542, 543 is connected to its own rectifying circuit where receiver coil 542 is connected to rectifying circuit 144 and receiver coil 543 is connected to rectifying circuit 545. A smoothing capacitor 146 is connected in parallel to the rectifying circuits 144, 545. A backscatter circuit such as circuit 150 in FIG. 1 may be included in the wireless power receiver 540. Other electrical components in the modified battery pack 500 are similar to those as shown in FIG. 1, and a description thereof will be omitted here for brevity.

FIG. 6 shows another modified battery pack 600 according to an embodiment of the present disclosure. Modified battery pack 600 is similar to modified battery pack 500 as shown in FIG. 5, with the exception that the wireless power receiver 640 comprises receiver coils 642, 643 that are connected to each other in series. As with receiver coils 542, 543 in FIG. 5, receiver coils 642, 643 are arranged at right angles to each other to provide full x-y rotational capability for wireless charging. In FIG. 6, the series combination of the receiver coils 642, 643 is connected to a single rectifying circuit 144, with smoothing capacitor 146 connected in parallel to the rectifying circuit 144. Other electrical components in the modified battery pack 600 are similar to those as shown in FIG. 1, and a description thereof will be omitted here for brevity.

Other objects, advantages and embodiments of the various aspects of the present invention will be apparent to those who are skilled in the field of the invention and are within the scope of the description and the accompanying figures. For example, but without limitation, structural or functional elements might be rearranged consistent with the present invention. While a power tool has been described in relation to the aforementioned embodiments, it should be understood that the inventive concepts described herein also apply to other power devices, such as medical devices and instruments. Similarly, principles according to the present invention could be applied to other examples, which, even if not specifically described here in detail, would nevertheless be within the scope of the present invention.

1. (canceled)

2. A battery-powered device comprising:
a control circuit;
a rechargeable battery connected to the control circuit and configured to provide electrical power to the device, the battery having a nominal battery voltage; and
a receiver circuit connected to the control circuit and configured to be electromagnetically coupled to a transmitter coil structure located external to the device,
wherein receiver circuit comprises a receiver coil structure having a longitudinal axis that is configured to direct magnetic flux induced by the transmitter coil in a transverse direction such that an output voltage of the receiver circuit is provided to the control circuit for charging of the battery.

3. The device of claim 2, wherein the receiver coil structure comprises at least one of:
single spiral coils, multiple spiral coils, longitudinal coils, or coils having any polarity structure.

4. The device of claim 2, wherein the receiver coil structure comprises a plurality of coils arranged orthogonally to each other.

5. The device of claim 4, wherein the coils are connected to each other in series or in parallel.

6. The device of claim 2, wherein the receiver coil structure further comprises ferrite shielding.

7. The device of claim 2, wherein the rechargeable battery comprises a battery casing, and the receiver circuit is integrated into the battery casing.

8. The device of claim 7, wherein the receiver circuit is hermetically sealed in the battery casing of the rechargeable battery.

9. The device of claim 2, wherein the output voltage of the receiver circuit is larger than the nominal battery voltage.

10. The device of claim 9, wherein the receiver circuit further comprises a backscatter circuit.

11. The device of claim 10, wherein the backscatter circuit uses at least one of:
capacitive modulation and resistive modulation.

12. The device of claim 11, wherein the receiver circuit further comprises a voltage divider or operational amplifier, coupled to the backscatter circuit, the voltage divider or operational amplifier configured to set the output voltage of the receiver circuit.

13. The device of claim 2, wherein the receiver circuit is electrically coupled to at least one of a positive terminal or a negative terminal of the control circuit via a diode.

14. The device of claim 13, wherein the diode comprises a field-effect-transistor based synchronous diode.

15. The device of claim 14, wherein the receiver circuit is configured to detect a forward-bias voltage of the diode, and set the output voltage of the receiver circuit to be larger than the forward-bias voltage.

16. The device of claim 2, wherein the battery powered device comprises any one of: a power tool and a medical device.

17. A wireless power transmitter comprising:
a transmitter coil having a longitudinal axis and configured to receive a time-varying current that flows in the transmitter coil,
the time-varying current configured to induce a magnetic flux in a receiver coil structure of a battery-powered device in a transverse direction and generate an output voltage in the receiver coil for charging a battery of the battery-powered device,
wherein the wireless power transmitter is hermetically sealed.

18. A rechargeable battery pack comprising:
a control circuit;
a rechargeable battery connected to the control circuit and configured to provide electrical power to a battery operated device, the battery having a nominal battery voltage; and
a receiver circuit connected to the control circuit and configured to be electromagnetically coupled to a transmitter coil structure located external to the battery pack,
wherein receiver circuit comprises a receiver coil structure having a longitudinal axis that is configured to direct magnetic flux induced by the transmitter coil in a transverse direction such that an output voltage of the receiver circuit is provided to the control circuit for charging of the battery.

19. The battery pack of claim 18, wherein the output voltage of the receiver circuit is larger than the nominal battery voltage.

20. The battery pack of claim 18, wherein the receiver circuit is hermetically sealed in the casing of the battery pack.

21. The battery pack of claim 18, wherein the receiver circuit further comprises a backscatter circuit.

22. The battery pack of claim 21, wherein the receiver circuit further comprises a voltage divider or operational amplifier, coupled to the backscatter circuit, the voltage divider or operational amplifier configured to set the output voltage of the receiver circuit.

23. The battery pack of claim 18, wherein the receiver circuit is electrically coupled to at least one of a positive terminal or a negative terminal of the control circuit via a diode.

24. The battery pack of claim 23, wherein the receiver circuit is configured to detect a forward-bias voltage of the diode, and set the output voltage of the receiver circuit to be larger than the forward-bias voltage.
